(19) United States
(12) Patent Application Publication
(10) Pub. No.: US 2007/0258480 A1
(43) Pub. Date: Nov. 8, 2007

(54) RESOURCE MANAGEMENT SYSTEM AND METHOD

(75) Inventor: Stefan Bengt Gustavsson, Helsingborg (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: SONY ERICSSON MOBILE COMMUNICATIONS AB, LUND (SE)

(21) Appl. No.: 11/555,284

(22) Filed: Nov. 1, 2006

Related U.S. Application Data
(60) Provisional application No. 60/804,288, filed on Jun. 9, 2006.

(30) Foreign Application Priority Data
May 5, 2006 (EP) 06113591.9

(51) Int. Cl. H04J 3/22

(52) U.S. Cl. 370/465; 370/401

(57) ABSTRACT

The invention relates to a resource management system and method for handling of devices with features incorporated in an apparatus, such as a mobile telephone, but implemented as separate entities and controlled through interfaces. The resource management system includes an interface proxy arranged to manage the availability of features and communication to the respective entity. The resource management system includes a managing device connectable through a physical interface to at least one entity comprising a number of feature devices. The interface proxy is associated with at least one entity for cooperation with the apparatus; and the interface proxy is adapted to handle resource allocation of the feature devices.

### FIELD OF THE INVENTION

The present invention relates to a resource management system and method for handling of devices with features incorporated in an apparatus, such as a mobile telephone, but implemented as separate entities and controlled through interfaces. The resource management system includes an interface proxy arranged to manage the availability of features and communication to the respective entity.

### BACKGROUND OF THE INVENTION

Electronic devices such as MP3 players and mobile phones often comprise a main apparatus which is connected to other entities usually incorporated in the same apparatus but implemented on a separate chip. The entities provide functions or features which add functions in the apparatus in a practical way from a manufacturing standpoint. In this application such functions or features are referred to as feature devices. Typically, the main apparatus manages the entities through a physical interface by means of a managing device. Actually the managing device itself may be implemented as a feature device.

The managing device communicates with the entities through a physical interface. The entities are provided with different interfaces to the managing device. The managing device has some knowledge of available feature devices through the physical interface. In some cases feature devices are discovered upon enumeration of the interface and in some rare cases enumeration upon interaction with the particular feature device. In a distributed system it is vital to enable enumeration based on activity or enumeration of other parts of the system, especially in the common case where many feature devices are just abstractions of a larger entity with multiple capabilities and resource sharing.

### SUMMARY OF THE INVENTION

It is an object of the present invention to provide a resource management system enabling dynamic resource allocation.

It is an object of the present invention to provide a resource management system enabling distributed processing and load handling.

According to a first aspect, the invention provides a resource management system for handling of feature devices incorporated in an apparatus, including a managing device connectable through a physical interface to at least one entity comprising a number of said feature devices, wherein

an interface proxy is associated with at least one entity for cooperation with the apparatus;
the interface proxy is adapted to handle resource allocation of the feature devices.

Preferably, the interface proxy is adapted to maintain a list of available feature devices.

Preferably, the interface proxy is adapted to dynamically update the list depending on availability.

In one embodiment, the interface proxy is virtually arranged in the entity.

In a further embodiment, the interface proxy is physically arranged in the entity.

The interface proxy may be arranged to handle all communication to the entity.

In one embodiment, the managing device is arranged to broadcast a request for a feature device to all interface proxies.

In a further embodiment, the managing device is arranged to broadcast a request for a feature device to interface proxies in a prioritised order.

According to a second aspect, the invention provides an apparatus incorporating a resource management system as defined above.

The apparatus may be a mobile telephone, a pager, a communicator, a smart phone, an electronic organiser, or an audio player.

According to a third aspect, the invention provides a method for handling of feature devices incorporated in an apparatus, including a managing device connectable through a physical interface to at least one entity comprising a number of said feature devices, wherein

an interface proxy is associated with at least one entity for cooperation with the apparatus;
the interface proxy handling resource allocation of the feature devices.

Preferably, the interface proxy maintains a list of available feature devices.

Preferably, the interface proxy dynamically updates the list depending on availability.

The interface proxy may handle all communication to the entity.

In one embodiment, the managing device broadcasts a request for a feature device to all interface proxies.

In a further embodiment, the managing device broadcasts a request for a feature device to interface proxies in a prioritised order.

The scope of the invention is defined in the accompanying claims.

### BRIEF DESCRIPTION OF THE DRAWINGS

The invention will be described in detail below with reference to the accompanying drawing of which:

FIG. 1 is a schematic representation of an embodiment of the invention.

### DETAILED DESCRIPTION OF PREFERRED EMBODIMENTS

The present invention is for example applicable in electronic devices such as a mobile telephones, pagers, communicators, smart phones, electronic organisers, or audio (MP3) players and accessories therefor. The description is focussed on components relevant to the specific objects and functions of the invention while other components may be conventional.

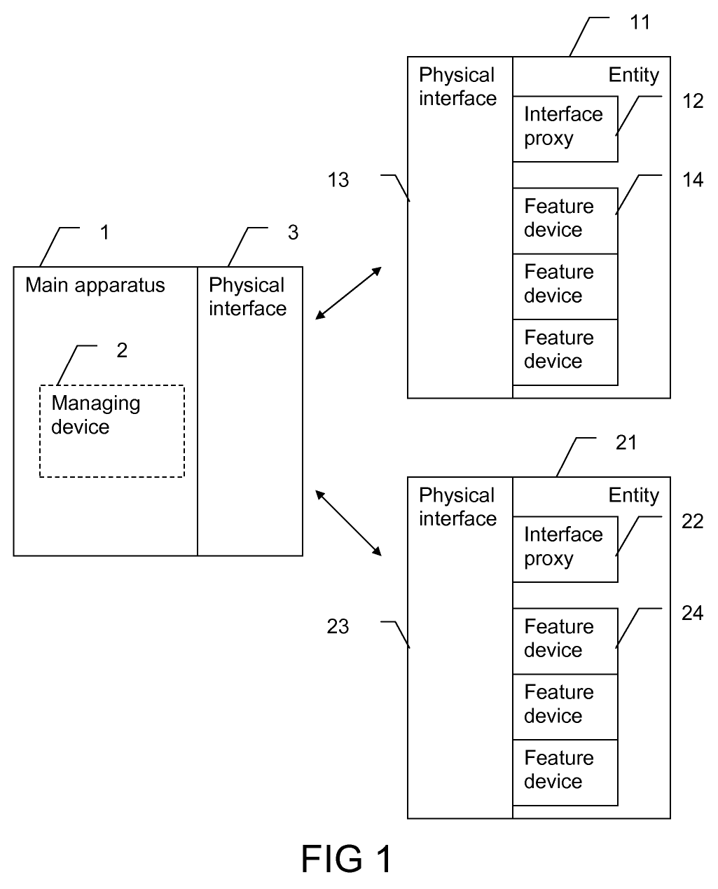

As shown in FIG. 1, a main apparatus 1, e.g. a mobile phone, comprises conventional components such as radio interfaces for communication, keypad, memories, and processors (not shown). Some functions are provided on separate entities 11, 21. The entities may be implemented on separate chips containing hardware or software programs devised to perform the wanted functions, in this specification referred to as feature devices 14, 24. In a mobile telephone, it may be practical to provide functions of audio decoding, video decoding and audio mixing on a separate chip. A managing device 2 of the main apparatus 1 is arranged to communicate with the feature devices 14, 24 when a specific function is required. The communication takes place through a physical interface 3 of the main apparatus 1 and respective physical interfaces 13 and 23 of the entities 11, 21.

The managing device 2 needs to identify attached devices and initialize the required routines (drivers) that enable them to function. This may take place upon enumeration of the physical interface 3 or enumeration upon interaction with the particular feature device 14, 24, i.e. when a specific function is required.

According to an embodiment of the invention a common interface device, an interface proxy 12, 22, is used in at least one entity 11, 21, preferably in every larger entity. The interface proxy 12, 22 may be implemented virtually or physically together with the entity 11, 21. This abstract interface proxy 12, 22 will handle the common communication regarding the physical interface 3, 13/23. It may be arranged to handle all communication to the entity 11, 21. Alternatively, the interface proxy 12, 22 is arranged to participate only in the resource allocation, and then the actual data communication to the entity 11, 21 takes place directly to the feature devices 14, 24 through the physical interface 13, 23.

The interface proxy 12, 22 is adapted to maintain a list of available feature devices 14, 24. To obtain information about the dynamic resource situation in a larger entity the interface proxy 12, 22 is asked for the list of available devices 14, 24 connected to this interface proxy 12, 22. The managing device 2 may broadcast a request to all entities 11, 21 or ask the interface proxies 12, 22 in a prioritised order. If the feature devices 14, 24 needed are available in the group of devices connected to this interface proxy 12, 22, they can be claimed, i.e. allocated and used. Then the listed is updated by the interface proxy 12, 22. The next request for a list of feature devices available to this interface proxy will give a different answer than the previous time if some feature devices 14, 24 are claimed. When the function is done and no longer required, the associated feature device 14, 24 is put back on the list. Thus, the list is maintained in dependence on the currently available resources.

It should be appreciated that the managing device itself may be implemented as a feature device. It need not be located in the main apparatus as shown in FIG. 1, but may be dynamically allocated in dependence of the current situation. In one embodiment it is possible for a current managing device to send a request for available managing devices in other entities 11, 21, so that the managing device may be reallocated. Thus, the location of the managing device is not fixed in the design process of the apparatus.

### Advantages of the invention are e.g.:

i) This arrangement connects the physical interface and uses the interface proxies for resource management. This will give a natural mechanism for distributed processing and load handling.
ii) It gives a method for dynamic resource allocation, in other words less overhead in processing power in the system with maintained performance.
iii) The invention can be a common way for dynamic device allocation.

The invention has been described with a certain degree of particularity, but modifications and variations may occur to persons skilled in the art. The scope of the invention is only limited by the claims below.

1. A resource management system for handling of feature devices incorporated in an apparatus, including a managing device connectable through a physical interface to at least one entity comprising a number of said feature devices, wherein
an interface proxy is associated with at least one entity for cooperation with the apparatus;
the interface proxy is adapted to handle resource allocation of the feature devices.

2. A resource management system according to claim 1, wherein the interface proxy is adapted to maintain a list of available feature devices.

3. A resource management system according to claim 2, wherein the interface proxy is adapted to dynamically update the list depending on availability.

4. A resource management system according to claim 1, wherein the interface proxy is virtually arranged in the entity.

5. A resource management system according to claim 1, wherein the interface proxy is physically arranged in the entity.

6. A resource management system according to claim 1, wherein the interface proxy is arranged to handle all communication to the entity.

7. A resource management system according to claim 1, wherein the managing device is arranged to broadcast a request for a feature device to all interface proxies.

8. A resource management system according to claim 1, wherein the managing device is arranged to broadcast a request for a feature device to interface proxies in a prioritised order.

9. A resource management system according to claim 1, wherein the managing device is implemented as a feature device.

10. An apparatus incorporating a resource management system as claimed in claim 1.

11. An apparatus according to claim 10, wherein the apparatus is a mobile telephone, a pager, a communicator, a smart phone, an electronic organiser, or an audio player.

12. A method for handling of feature devices incorporated in an apparatus, including a managing device connectable through a physical interface to at least one entity comprising a number of said feature devices, wherein
an interface proxy is associated with at least one entity for cooperation with the apparatus;
the interface proxy handling resource allocation of the feature devices.

13. A method according to claim 12, wherein the interface proxy maintains a list of available feature devices.

14. A method according to claim 13, wherein the interface proxy dynamically updates the list depending on availability.

15. A method according to claim 12, wherein the interface proxy handles all communication to the entity.

16. A method according to claim 12, wherein the managing device broadcasts a request for a feature device to all interface proxies.

17. A method according to claim 12, wherein the managing device broadcasts a request for a feature device to interface proxies in a prioritised order.
